(19) United States
(12) Patent Application Publication
(10) Pub. No.: US 2004/0127133 A1
(43) Pub. Date: Jul. 1, 2004

(54) Accumulated layer of structure fabric mixed with adsorption active carbon and resin

(76) Inventor: Cheng Lin Chuang, Taichung City (TW)

Correspondence Address: BACON & THOMAS, PLLC, 625 SLATERS LANE, FOURTH FLOOR, ALEXANDRIA, VA, 22314

(21) Appl. No.: 10/330,076

(22) Filed: Dec. 30, 2002

(51) Int. Cl. B32B 3/00; B32B 5/02; B32B 9/00

(52) U.S. Cl. 442/417; 442/59; 442/381; 442/394

(57) ABSTRACT

The present invention relates to an accumulated layer of structure fabric mixed with adsorption active carbon and resin comprising the upper layer is made of fabric or non-woven fabric or TPU film, TPE film, PU film, PP film, the middle layer is made of mixing active carbon and wetting reactive resin; the lower layer is made of various kinds of fabrics processed by spraying on the lower layer and resin with the upper layer. In this way, the middle layer of active carbon capable of strong absorbability, which can absorb the body's bad smell of perspiration as well as the whole fabric has the function of keeping body warm. Besides, this invention can be used in outdoors clothing, hats, masks, gloves, shoe-pads, underwear such as brassiere, filtering materials, protecting clothes and socks.

### FIELD OF THE INVENTION

The present invention relates to an accumulated layer of structure fabric mixed with adsorption active carbon and resin, especially to the application of an active carbon mixed resin layer in the fabric.

### BACKGROUND OF THE INVENTION

The general way to make active carbon layer fabric is to make by compounding carbon powder and fiber, which unit price is considered quite high. The other is to make by way of spraying carbon powder, which the size of the carbon pellet is too bigger. As shown in FIG. 1, the main procedure is to cover fabric layer A with resin into film layer B and spray active carbon powder on film layer B into active carbon layer C and then process sticking with another fabric layer or resin coating layer D, where the active carbon pellet in use is rougher because slenderer active carbon will emerge from the fabric after being washed. As shown in FIGS. a-a′, it is the status of active carbon C1 emerge from the fabric. After being washed, the activity of the carbon will lessen the surface of the fabric and easily become wrinkle. Therefore, the absorbability of the whole fabric will become worse and the water-proof will be bad as well. Another way of making is to mix the active carbon and resin processed with non-woven fabric immersing so as to stick the carbon powder onto the material and be done after being dried. This is a way of making masks and that of more filtering materials or to stick with the fabric. This needs to be resin coating with fabric or to be processed with needle punching, which is regarded without environmental protection and simplicity as well as not endurable of being washed and bad absorbability.

### SUMMARY OF THE INVENTION

Upon resolving the above defects, the invention applies for the patent of “an accumulated layer of structure fabric mixed with adsorption active carbon and resin”. The purpose of the invention is to make by mixing active carbon and wetting reactive resin as the middle layer so that whatever size of the active carbon pellets and the 3 layers can be processed and done without emerging from the fabric and has the functions of carbon activity. The whole fabric has excellent absorbability, conductivity of electricity,waterproof, not easily wrinkled, and heat dry endurance as well as its process of making is simple.

The features and functions of the purposes of the invention can be described by the following better practical examples in accommodation with drawings and figures as follows:

### BRIEF DESCRIPTION OF THE DRAWING

FIG. 1 shows the prior art is process of the layer cloth with active carbon

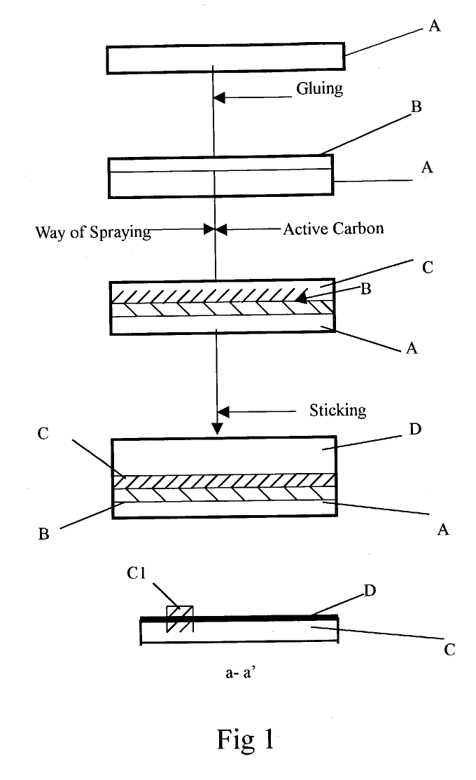

FIGS. a-a′ shows how active carbon emerge from the cloth layer.

FIG. 2 shows the making process of the layer cloth with active carbon mixed with resin layer of the invention.

FIG. 3 shows the sectional drawing an accumulated layer of structure fabric mixed with adsorption active carbon and resin of the invention.

FIGS. b-b′ shows the active carbon mixed with resin layer of the invention.

### DETAILED DESCRIPTION OF THE PREFERRED EMBODIMENTS

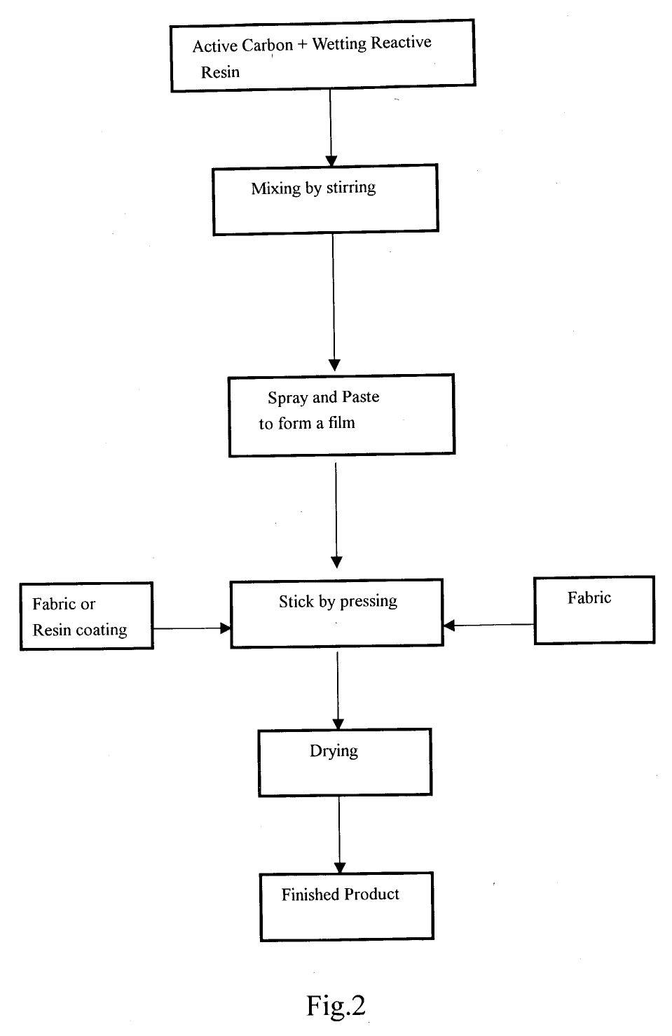

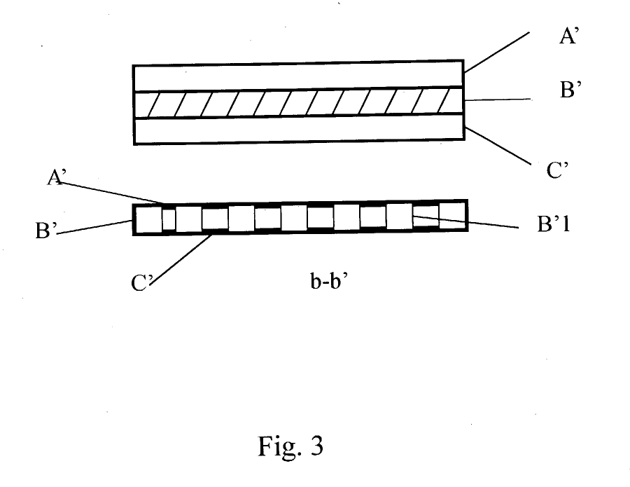

The invention is an accumulated layer of structure fabric mixed with adsorption active carbon and resin. FIG. 2 shows the making process of the layer cloth with active carbon mixed with resin layer of the invention, which mixes and stirs with different ratio of active carbon and wetting reactive resin into resin shapes and spray or paste them onto the fabric so as to fort active carbon mixed layer B′, of which the paste quantity is 20˜50 g/m² FIG. 3 shows the thin coating layer B′ formed on fabric layer C′ stuck with another fabric layer or film layer A′ to be processed 85 into a finished product. FIGS. b-b′ shows active carbon resin mixed layer B′ between the fabric layer or film layer A′ and fabric layer C′. Among them, active carbon B′1 does not emerge from the fabric layer. The active carbon will be activated after being dried.

Practical Examples

First, mix 10˜90% weight percentage of wetting reactive resin with 0.1˜3% weight percentage of active carbon, which the size of the pellets of the active carbon are nanometer scale (10⁻⁹ m) to 0.1 m/m. The proceed is mixing and stirring to form mixed resin and spray and paste with 20˜100 g/m² paste quantity as paste layer B′. Besides, use fabric as fabric layer C′ spraying and pasting onto the surface of the layer and proceed sticking with non-woven fabric, knitting fabric, plain woven fabric, TPU film (except for PTFE film) and color fabric under the speed of 5˜30 yd/min and sticking temperature (40˜120° C.). Then they are dried to be done into finished products.

The way to test according to the above terms: to test with ASTM D3467-94 which cut the sample active carbon cloth into a square cloth with 10 cm in length and width and 100 cm2 in square measure, then roll up into a cylinder shape and put into the test tube to carry out the test result table of the absorbability of carbon tetrachloride as follows:

TABLE 1

| | | Quantity of absorbability |
|---|---|---|
| No. | Description | (Unit: gCCl₄/100 cm²) |
| 01 | INTERLOCK + CS + 20 gm | 0.0933 |
| | non-woven fabric | 0.0928 |
| | | 0.0876 |
| | | 0.0863 |
| 02 | INTERLOCK + CS + 240 g Color | 0.0989 |
| | Fabric | 0.0885 |
| | | 0.0868 |
| | | 0.0884 |
| 03 | INTERLOCK + CS + Raintex-TPH | 0.0993 |
| | FILM | 0.1229 |
| | | 0.1259 |
| | | 0.0958 |
| 04 | INTERLOCK + CS + Raintex-TRL | 0.1741 |
| | FILM | 0.1723 |
| | | 0.1656 |
| | | 0.1616 |
| 05 | INTERLOCK + CS + Plain woven | 0.1294 |
| | Fabric | 0.1287 |
| | | 0.1263 |
| | | 0.1303 |

Notes:

1. INTERLOCK: Knitting fabric

2. CS: Active carbon+Wetting Reactive Resin

3. Raintex-TRL FILM, Raintex-TPH FILM: TPU FILM, TPE FILM, PU FILM, PP FILM.

One can learn from above that the invention mixes the active carbon and wetting reactive resin as the middle layer of the layer composition and then uses the features of the fabric or resin coating as three layer composition processed at one time. Obviously, after the test of ASTM D3467-94, its absorbability has become better and so do its waterproof and dry endurance.

What is claim is:

1. An accumulated layer of structure fabric mixed with adsorption active carbon and resin comprising: the upper layer is fabric layer or film layer; the lower layer is non-woven fabric layer or fabric layer; its feature is in the middle layer which is a mixture of 1˜3% weight percentage of active carbon and 10˜90% weight percentage of wetting reactive resin and thus form active carbon mixed resin and proceed spraying with spraying quantity of 20˜100 g/m² and then stuck and dried to be done. This product can absorb the body's bad smell of perspiration as well as the whole fabric has the function of keeping body warm. Besides, this invention can be used in outdoors clothing, hats, masks, gloves, shoe-pads, underwear such as brassiere, filtering materials, protecting clothes and socks.

2. An accumulated layer of structure fabric mixed with adsorption active carbon and resin as defined in claim 1, wherein is made of various kinds of wood plants such as coconut shells, elms, timber of a Chinese cypress and bamboos and has absorbability. Each material contains different effectiveness.

3. An accumulated layer of structure fabric mixed with adsorption active carbon and resin as defined in claim 1 or 2, wherein an active carbon is made of coconut shells. The comparison of are are 110 g/m² on surface.

4. An accumulated layer of structure fabric mixed with adsorption active carbon and resin as defined in claim 1, wherein the size of active carbon of the is from 10⁻⁹ m to 0.1 m/m.

5. An accumulated layer of structure fabric mixed with adsorption active carbon and resin as defined in claim 1, wherein the upper layer is TPU film, PP film and TPE film.
